(19) United States
(12) Patent Application Publication
(10) Pub. No.: US 2010/0248192 A1
(43) Pub. Date: Sep. 30, 2010

(54) SIMULATED INTERACTIVE FINANCIAL EDUCATION GAME

(76) Inventors: Sara J. Thompson, Mooresville, NC (US); Samantha M. Edwards, Huntersville, NC (US)

Correspondence Address: Russ Weinzimmer, 614 Nashua Street, Suite 53, Milford, NH, 03055, US

(21) Appl. No.: 12/413,754

(22) Filed: Mar. 30, 2009

(51) Int. Cl. G09B 19/00

(52) U.S. Cl. 434/107

(57) ABSTRACT

A simulation game method is disclosed for teaching basic personal financial skills and the application thereto of character, time management, responsibility, and accountability. A user completes instruments such as checks and time slips, and receives directly responsive financial statements, such as bank statements and credit card statements, as well as financial demands such as invoices and credit card statements that simulate both planned and unexpected expenses. A simulated game period, such as six weeks, can proceed at a compressed rate. The game can require incurring of debt, but allow for debt elimination through skillful financial management. Guidance and suggestions can be provided by a managing staff, and a game score can be based on demonstrated financial responsibility and/or quality of life achieved. The game can be played using paper statements prepared by a supervising staff, on a local computer, or on a remote computer accessed over the internet.

### FIELD OF THE INVENTION

This invention pertains generally to the field of educational games, and more particularly to financial educational games.

### BACKGROUND OF THE INVENTION

Almost every adult must cope with the realities of managing their finances. A source of income must be established, submission of timesheets may be required before income is received, a bank account must be maintained, bills must be paid, credit must be managed, and discretionary expenses such as entertainment and luxury purchases must be managed so as to make life as enjoyable as possible while continuing to pay for necessities and cope with any unexpected problems and expenses.

The present world introduces substantial complexity and variability into the problem of paying bills due to the presence of various financial instruments such as interest bearing checking accounts, overdraft protection, automatic teller machines, online payments, automatic withdrawal programs offered by some creditors, debt consolidation loans and the ready availability of credit cards. The monetary needs of a child are typically managed by a parent. In the past, a parent could introduce a child into the world of financial responsibility simply by giving the child an allowance or opening a savings account in the child's name. In the present world such actions are insufficient to prepare a young person for the realities of dealing with their money once they become responsible for their own lives.

The need to provide education regarding financial responsibility has been recognized in the past. For example, U.S. Pat. No. 5,071,135, entitled “BOARD GAME APPARATUS FOR THE TEACHING OF FINANCIAL MANAGEMENT PRINCIPLES”, issued on Dec. 10, 1991 to Campbell, discloses a game for teaching personal finance principles, including an income and expense balance sheet. However, the game is directed primarily towards building the greatest net worth, and does not provide a realistic teaching of how to responsibly manage the full range of individual finances.

Computers are now generally accessible to most children, and in many situations computer implemented simulations and games are deemed to be more suitable than traditional board games for purposes of instruction. Interactive, computer-based learning that includes a business simulation component is disclosed in U.S. Pat. No. 7,280,991, entitled “CREATING COLLABORATIVE SIMULATIONS WITH MULTIPLE ROLES FOR A SINGLE STUDENT”, issued on Oct. 9, 2007 to Beams, et al. However, Beams et. al. is directed mainly toward management of a business, and does not teach basic personal finance management.

An example of a financial simulator using computer processing techniques is disclosed in U.S. Pat. No. 6,430,542, entitled COMPUTER IMPLEMENTED PROGRAM FOR FINANCIAL PLANNING AND ADVICE SYSTEM, issued on Aug. 26, 1998 to Moran. However, the Moran system does not teach day-to-day personal finance skills, but instead is directed generally towards creating a valuable estate and properly managing its disposition upon death.

A system that is adaptable to both board game and computer use is disclosed in U.S. Pat. No. 6,767,210, entitled METHOD OF TEACHING FINANCIAL MANAGEMENT, issued on Jul. 27, 2004 to Joffe. However, the main focus of the Joffe method is the teaching of basic accounting principles, and not personal financial skills.

There are numerous disadvantages to the methods of financial instruction just described. First, they emphasize wealth building, rather than teaching the skills needed to manage everyday, personal finances. Second, they do not provide immediate, individual interaction and feedback regarding the management of personal finances. Third, they assume a level of expertise which is greater than that possessed by most people when they obtain their first job, first leave their childhood home, or otherwise achieve either partial or total financial independence for the first time.

### SUMMARY OF THE INVENTION

A method is claimed for teaching personal financial management skills to a student by enabling the student to play a financial simulation game, and providing direction and feedback to the student during and after game play. The method teaches basic financial skills and their relationship to the principles of character, time management, responsibility, and accountability. The invention is useful and accessible to a child or adult having no real knowledge of or experience in even the most basic concepts related to managing finances. The present invention introduces a user to the basic financial instruments actually encountered by a person of modest means living in the real world. The student participates in game play by completing and submitting simulated financial instruments, such as checks and time slips, which realistically simulate real-life financial transactions. Simulated financial statements, such as bank statements and paychecks, that directly respond to the submitted financial instruments, are then prepared and delivered to the student. In preferred embodiments, financial demands such as invoices and credit card statements are also prepared and delivered to the student so as to simulate real-life expenses, both planned and unexpected, and thereby solicit submission by the student of additional payments and other financial transactions.

In some preferred embodiments, the game is played using paper statements prepared by a teacher or other monitoring individual who manages the overall play of the game and provides feedback and instruction as needed. In other preferred embodiments, the game is computer implemented, on a local computer and/or on a computer that is accessible to the participant over the internet. In certain preferred embodiments, simulated payments, time slips, and such like are prepared on a local computer and then transmitted to a remote server, after which documents such as simulated paychecks and/or invoices are received therefrom. This interaction with a remote server enables the progress of the user to be monitored, and guidance and suggestions to be provided as appropriate, by remote staff personnel who are coordinate with the server.

In some preferred embodiments, the simulation proceeds for a specified period of time, such as a simulated six week period, and in some embodiments the simulation proceeds at twice real time, for example providing simulated “two week” paychecks every week and “monthly” rental invoices every two weeks.

One general aspect of the present invention is a method for teaching financial management skills to a student through play of a financial simulation game. The method includes providing to the student simulated financial instruments which enable the student to perform simulated financial transactions, receiving simulated financial transactions performed by the student, providing to the student simulated financial statements that are responsive to the simulated financial transactions performed by the student, providing to the student simulated financial demands that require the student to perform responding financial transactions, and repeating the above actions so as to simulate real financial activity transacted during a predetermined period of time.

In preferred embodiments the simulated financial instruments include employment timesheets, checks, a checkbook register, a credit card, and/or bank deposit slips. In some preferred embodiments the simulated financial statements include bank statements, payment receipts, and/or credit card balance statements. And in various preferred embodiments the simulated financial demands include bills for rent payments, bills for food purchases, bills for clothing purchases, bills for car payments, bills for payment of taxes, bills for entertainment expenses, bills for regular medical care, bills for unexpected medical care; and/or bills for unexpected automobile repairs.

In certain preferred embodiments the financial demands include financial demands that require the student to incur and manage simulated debt. And in some of these embodiments the financial demands are configured so as to make incurring of debt unavoidable during a first portion of the predetermined period of time, while enabling the incurred debt to be eliminated during a second portion of the predetermined period of time.

In some preferred embodiments at least some of the financial instruments are completed on paper and submitted to a game supervision staff, and the financial statements and financial demands are prepared by the game supervision staff and provided to the student on paper.

In other preferred embodiments at least some of the financial instruments are entered by the student into a computer, and the financial statements and financial demands are delivered to the student by the computer. In some of these embodiments the computer is a personal computer that is locally available to the student, and/or a server accessed by the student over at least one of a network and the internet. In other of these embodiments at least some of the financial instruments are provided to a remote supervising computer, and the financial statements and financial demands are prepared by the remote supervising computer. And in some of these embodiments the remote computer communicates with the student via the internet.

In preferred embodiments feedback is provided to the student by a game management staff. And in some of these embodiments the feedback includes at least one of advice regarding how to play the game and indications of a degree of success demonstrated by the student while playing the game.

In certain preferred embodiments the predetermined period of time is six weeks. And in various preferred embodiments the predetermined period of time represents a compression of real time.

In preferred embodiments a summary report is provided to the student at the end of the predetermined period of time. In some of these embodiments the summary report includes timeliness of submission of employment time sheets, timeliness of bill payments, frequency of rejection of submitted checks due to insufficient bank account funds, total amount of credit card interest paid; and/or total amount of luxuries purchased. And in some preferred embodiments a game score is awarded to the student at the end of the predetermined period of time.

Another general aspect of the present invention is an article of manufacture for teaching financial management skills to a student through play of a financial simulation game. The article of manufacture includes media containing software operable on a computer so as to cause the computer to provide to the student simulated financial instruments which enable the student to perform simulated financial transactions, receive simulated financial transactions performed by the student, provide to the student simulated financial statements that are responsive to the simulated financial transactions performed by the student, provide to the student simulated financial demands that require the student to perform responding financial transactions, and repeat the above actions so as to simulate real financial activity transacted during a predetermined period of time.

In preferred embodiments, the computer is a remote computer that is able to receive simulated financial instruments from the student and to provide simulated financial statements and simulated financial demands to the student via communication over at least one of a network and the internet.

### BRIEF DESCRIPTION OF THE DRAWINGS

The invention will be more fully understood by reference to the detailed description, in conjunction with the following figures, wherein:

FIG. 1A is a flow diagram indicating the activities included in each simulated week of a simulated six-week game in a preferred embodiment;

FIG. 1B is a graph illustrating a typical example of the weekly levels of debt and luxury expenses of a user playing the game of FIG. 1A;

FIG. 1C is a flow diagram indicating the overall structure of a preferred embodiment, including the interaction between a user and a supporting staff;

FIG. 2 is a front view of a simulated timesheet utilized by the embodiment depicted in FIG. 1C;

FIG. 3 is a front view of a simulated deposit slip utilized by the embodiment depicted in FIG. 1C;

FIG. 4 is a front view of a simulated check register utilized by the embodiment depicted in FIG. 1C;

FIG. 5 is a front view of a simulated invoice utilized by the embodiment depicted in FIG. 1C;

FIG. 6 is a front view of a simulated credit card utilized by the embodiment depicted in FIG. 1C;

FIG. 7 is a front view of a simulated check utilized by the embodiment depicted in FIG. 1C;

FIG. 8 is a front view of a simulated bank statement utilized by the embodiment depicted in FIG. 1C;

FIG. 9 is a back view of a simulated bank statement utilized by the embodiment depicted in FIG. 1C; and

FIG. 10 is a front view of a report utilized by the embodiment depicted in FIG. 1C.

### DETAILED DESCRIPTION OF THE PREFERRED EMBODIMENTS

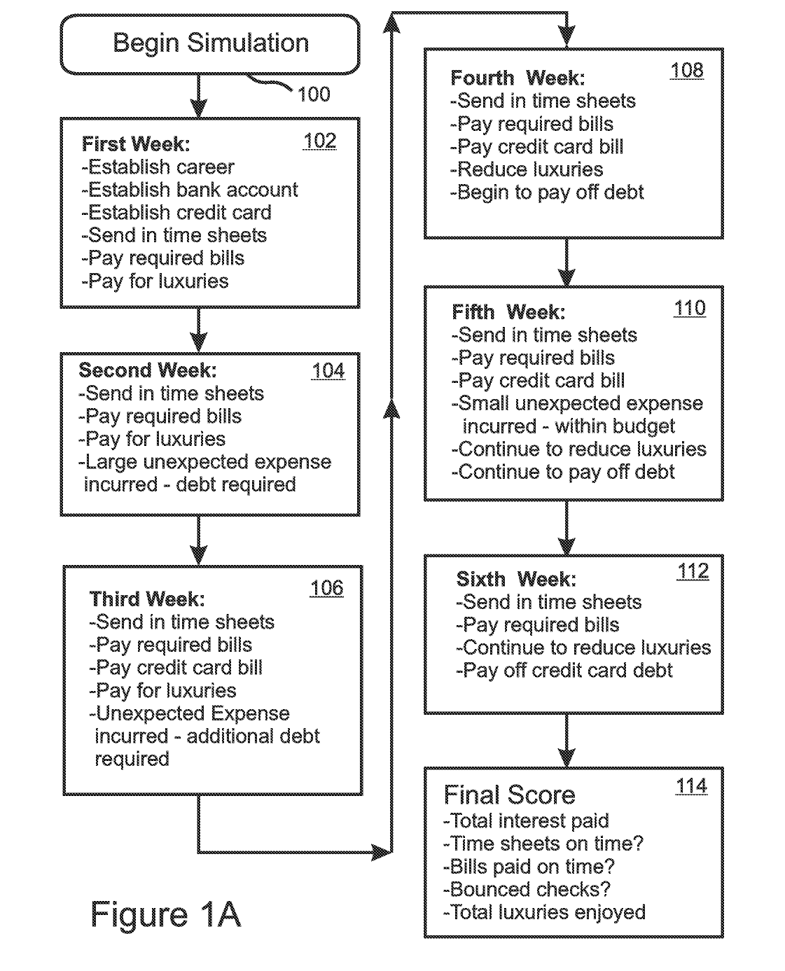

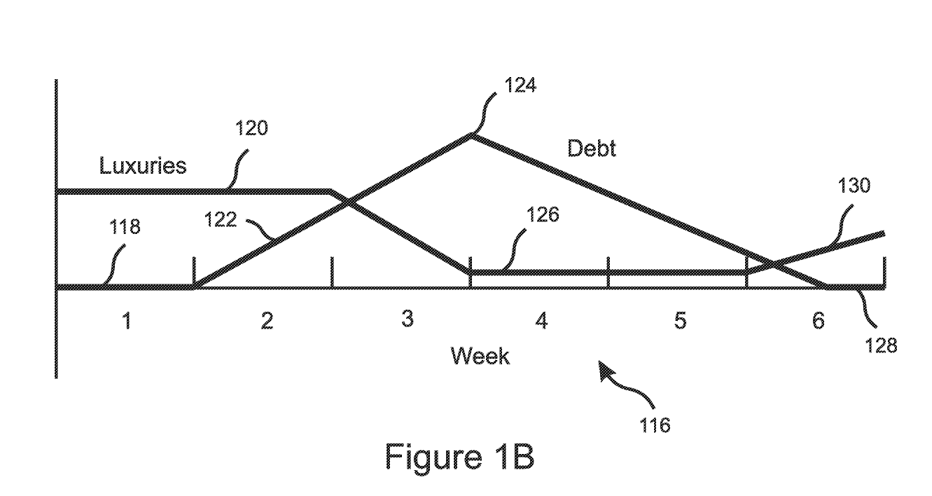

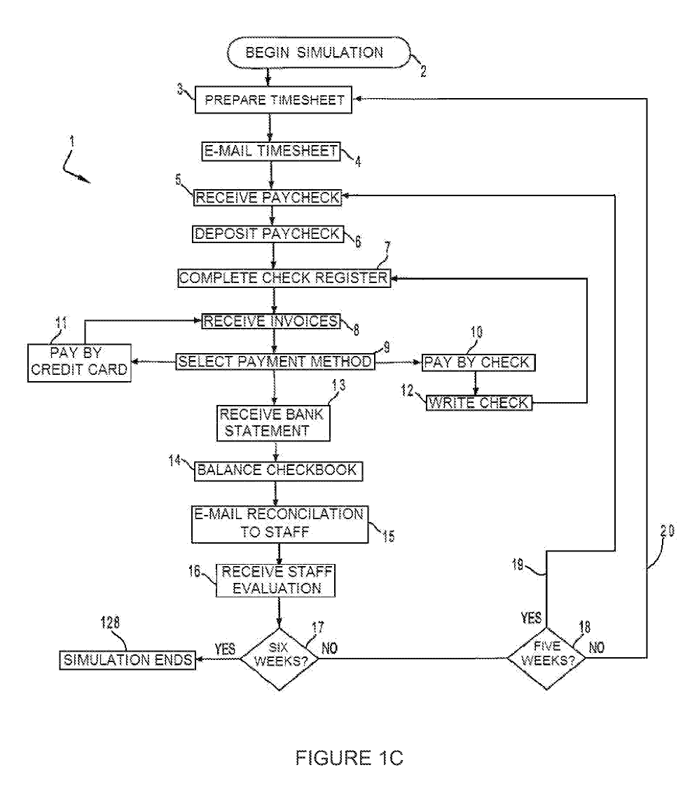

Referring to FIG. 1A, the present invention is a simulation game that teaches everyday financial skills to individuals who are inexperienced in the management of bank accounts, credit cards, and other everyday financial tools, and who are also inexperienced in the art of balancing entertainment and luxuries with expected and unexpected financial requirements. In the preferred embodiment of FIG. 1A, the game is a simulation of a six week period of time. So as to maximize its teaching potential, the game is specifically designed to require that a player encounter debt during the first three simulated weeks, and then be given the opportunity to work out of debt during the second three simulated weeks. So as to discourage unrealistically conservative behavior, the final score for the game rewards quality of life as well as financial responsibility, by awarding points for luxuries and entertainment as well as for responsibly paying bills and avoiding excessive debt. The utility and realism of the game is thereby enhanced by not only teaching basic financial skills, but also providing a realistic simulation of the need in real life to balance quality of life with financial responsibility.

In the embodiment of FIG. 1A, the game begins 100 in the first week with selection of a career and establishment of a bank account and a credit card. In various embodiments, careers can be chosen based on how many years of schooling the user plans to complete, how many hours per week the user is willing to work, and other personal preferences. In some embodiments, bank accounts and credit cards can be selected depending on various, realistic factors such as bank account and credit card interest rates. In some preferred embodiments, actual bank and credit card information is used, so as to make the simulation even more realistic, and in some of these embodiments the materials are provided by actual banks and credit card companies as an opportunity to promote their services to future customers.

Play of the game then begins with submission of time sheets, payment of any initial bills (such as the first month's rent, car payment, and groceries), and payment for any entertainment and/or other luxuries that the user elects, such as restaurants, movies, cable television, and such like. Orders for new services such as cable television are provided by the game and completed and submitted by the user. Invoices for expenses such as rent, car payments, cable television, and such like are provided to the user by the game, either due to manual preparation by a game manager, or automatically by software in the case of a computer-implemented game. These expenses are then paid by the user using a simulated checkbook.

During the second week 104, in addition to submission of time sheets and payment for weekly expenses and optional luxuries, a large and unexpected expense, such as a major car repair, is automatically simulated by the game manager or by the game software. This unexpected expense is purposely adjusted so as to be greater than the bank balance of the user, thereby forcing the user to use his or her credit card to go into debt.

During the third week 106, a credit card bill is added to the other invoices submitted to the user by the game. So as to ensure that the user understands that unexpected expenses can happen at any time, in the embodiment of FIG. 1A an additional, unexpected expense is encountered during the third week, and the user is forced to go further into debt.

During the fourth week 108, the credit card bills continue, and the user is there by encouraged to reduce discretionary, luxury spending so as to begin to pay off the debt. This continues during the fifth week 110, where in this embodiment another unexpected expense is encountered, which in this instance is purposely adjusted to be small enough to nevertheless allow the user to continue reducing the debt. During the final, sixth week 112, if the user has managed his or her finances carefully, the debt is finally paid off. Scoring of the game 114 is based partly on factors that reflect financial responsibility, such as total interest paid, timely submission of timesheets and payment of bills, number of bounced checks (if any). However, points are also awarded based on the total luxuries enjoyed, thereby rewarding the user not just for financial responsibility, but also for finding an optimal balance between financial responsibility and quality of life.

FIG. 1B is a graph that illustrates the fluctuations discretionary spending on luxuries 118 and in debt 120 during the course of the game of FIG. 1A. During the second week, debt begins to rise 122 due to the unexpected expenses that are encountered, and reaches a peak 124 at the end of the third week. In the example of FIG. 1B, the user does not initially react, but realizes the problem by the end of the second week and responds by reducing luxury spending to a very low level 126. During the fourth and fifth weeks, this spending restraint begins to pay off, as the debt is reduced. Finally, during the sixth week, the debt is paid off 128, and the user is able to increase luxury spending 130, although wisely choosing a level that is not as high as during the first week, thereby choosing to accumulate some savings to be used in case of future unexpected expenses.

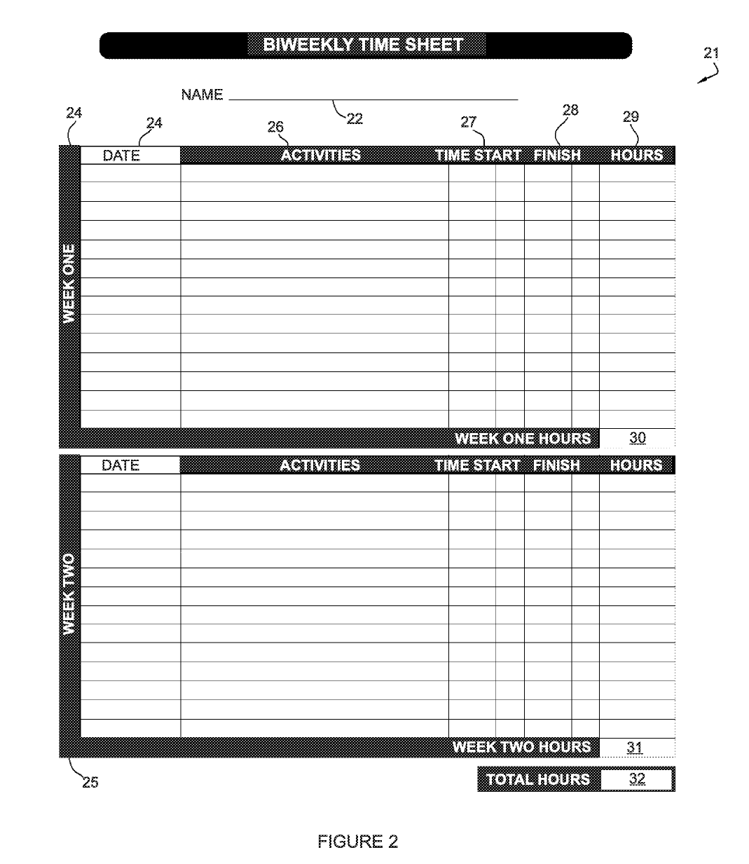

FIG. 1C is a flow diagram that presents a more detailed description of the steps followed by a participant in the embodiment 1 of FIG. 1A. FIGS. 2-10 illustrate financial documents used during play of the game in this embodiment. The embodiment 1 is implemented either on paper, or as software operating on a personal computer to which a participant has access, and/or as software that can be accessed by a participant via a personal computing device having an internet connection. In all cases, the embodiment 1 includes a simulation manager, and preferred embodiments include at least one human supervisor who can interact with the participant. In various embodiments, the simulation manager can be a parent, a teacher, or a staff offering the game as a hosted service over the internet.

After the simulation has begun 2, the first step 3 undertaken by the participant in the simulation is to prepare a timesheet.

FIG. 2 illustrates a timesheet 21 used in a preferred embodiment. The timesheet 21 includes a line 22 for the participant to enter his or her name. The timesheet 21 includes a first section 24 for entering data pertaining to a first week and a substantially identical section 25 for entering data pertaining to a second week of activities. Each section 24 and 25 includes a column 23 for entering the date of work, a column 26 for describing the work activity, a column 27 for listing the time at which the activity began, a column 28 for entering the time at which the activity ended, and a column 29 for entering the total hours worked on each date that pertained to a particular activity. A data field 30 is provided for entering the total hours worked during the first week, as well as a data field 31 for the total hours worked during the second week. Data field 32 is the sum of the hours entered in data fields 30 and 31.

The participant in the simulation is typically a full time student living at home. Accordingly, the activities entered on the timesheet 21 that qualify as work for the purposes of the simulation include hours attended at school, after school activities, church attendance, and any legitimate part time job. An hourly rate of pay will be assumed and will be based on the typical starting salary of a profession chosen by the participant. The Grade Point Average (GPA) of the participant must be sufficient, based on a table correlating GPA and reasonable occupational requirements, to support the profession and the corresponding salary selected by the participant. In a preferred embodiment of the invention, the timesheet 21 must be forwarded at step 4, typically by electronic mail (e-mail), to the staff each Friday before 5:00 P.M. In a paper-implemented embodiment of the present invention, the timesheet 21 is mailed using a real or simulated postal service, and must be postmarked each Friday no later than 5:00 P.M.

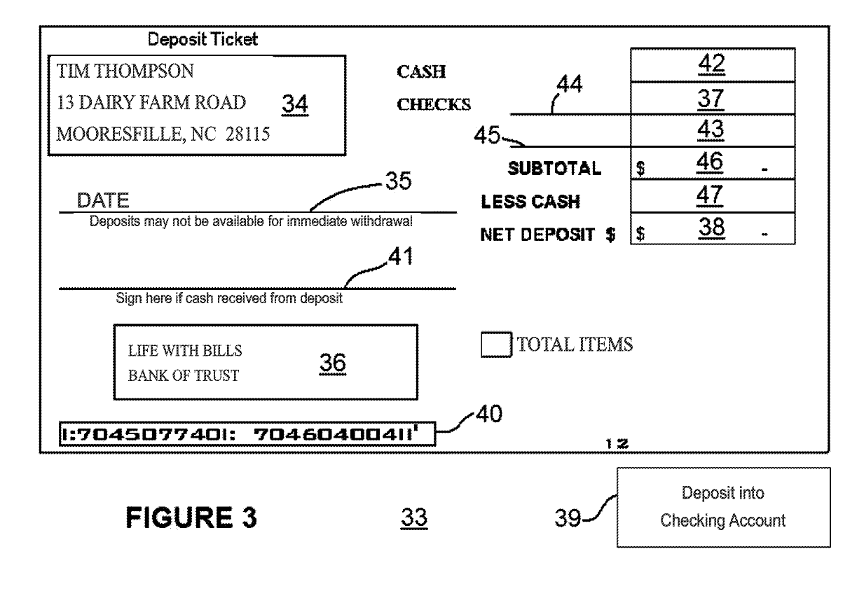

For each simulated two week period covered by the timesheet 21, the participant receives a simulated paycheck, which will typically be e-mailed or mailed to the participant within three days of staff receipt of the timesheet 21. Any delay in staff receipt of the timesheet 21 will result in a corresponding delay in receipt by the participant of the simulated paycheck at step 5 of the simulation. Once the simulated paycheck is received by the participant, the paycheck must be deposited at step 6 into a simulated checking account using the deposit slip 33 depicted in FIG. 3. The deposit slip 33 is customized to include the name of the system participant in data field 34, as well as an account routing number 40 corresponding to the simulated bank appearing in data field 36. The deposit slip 33 also includes a line 35 for entering the date of deposit and a signature line 41 for the signature of the participant. The deposit slip 33 includes a data field 42 for entering cash deposits, data fields 37 and 43 for entering the amount of deposited checks, and a data field 46 for the subtotal of data fields 37, 42 and 43. Any cash retained by the participant is entered in data field 47, and the total of the net deposit to the bank account is entered in data field 38. If the deposit slip 33 is being completed via a personal computer, the button 39 is activated by a suitable pointing device to forward the deposit slip to the simulated bank.

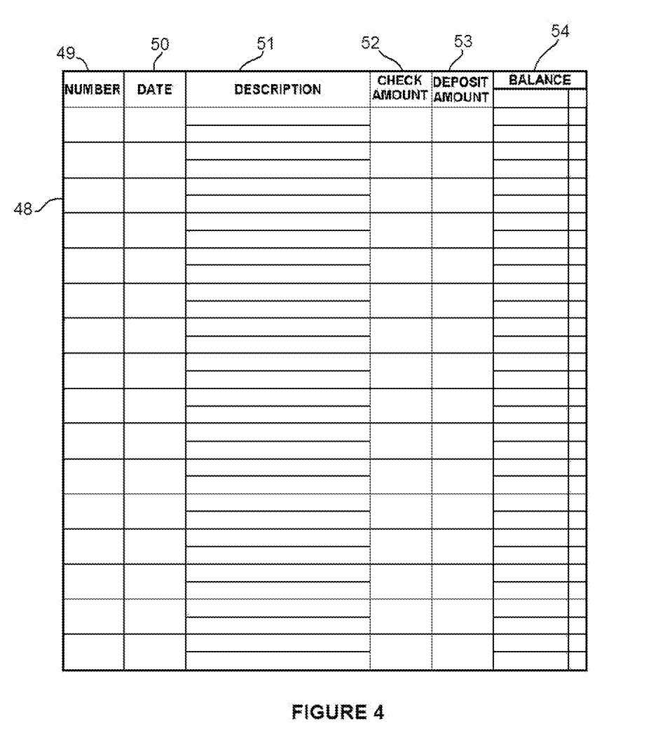

Referring also to FIG. 4, the next step 7 performed by the simulation participant is to enter the transaction of step 6 into a check register 48. The check register 48 includes a column 48 for the check number, a column 50 for the date of the deposit, a column 51 for listing the source of the check, a column 52 to be used to list the amount of subsequently written checks, a column 53 for entering the amount of the deposited check and a column 54 for listing the amount of funds remaining in the simulated checking account.

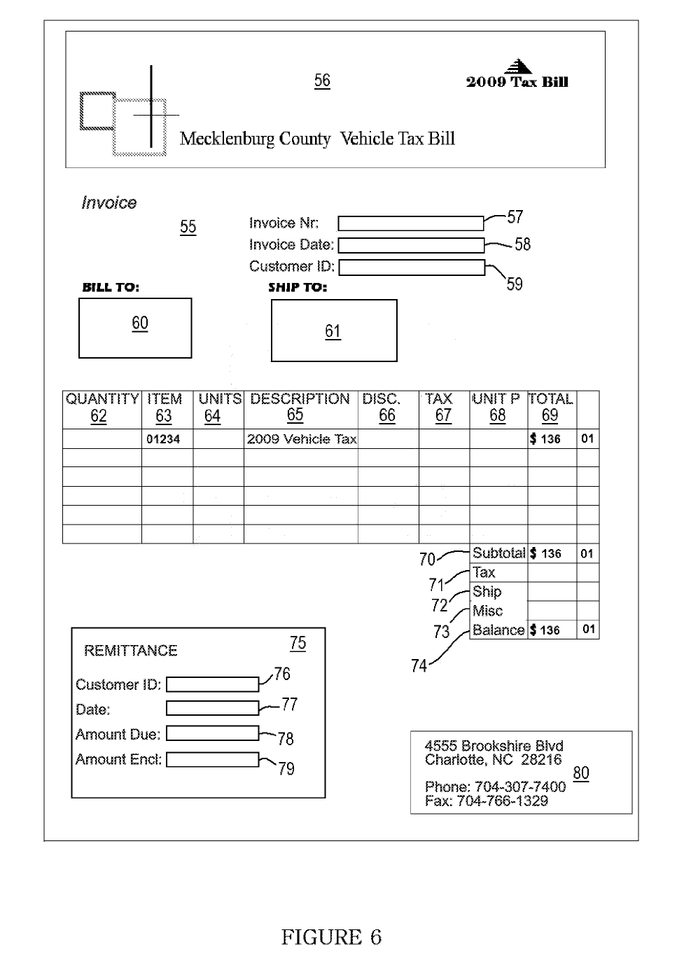

As a result of receiving a simulated paycheck, the participant in the system 1 now has funds in a simulated checking account. The participant then begins to receive invoices at step 8 that have been generated by the simulation software and/or the simulation management staff. Some of the invoices will be predictable and recurring, such as rent and utility bills, while other invoices will correspond to unexpected expenses such as automobile repairs. A typical invoice 55 is depicted in FIG. 6, and includes, for example, data field 80 containing creditor contact information, data field 56 listing the name of the creditor, data field 57 listing the invoice number, data field 58 listing the invoice date and data field 59 listing the customer identification number. While each invoice 55 differs in particular details, other generic information is included such as data field 60 for the customer billing address and data field 61 for the customer shipping address.

Specific information regarding the goods or services that are the subject of the invoice are included on the invoice 55, such as the quantity of goods in column 62, the item number in column 63, the number of units corresponding to a single item number in column 64, a description of the product or service in column 65, any applicable discount in column 66, the portion of the charge that is taxable in column 67, the unit price in column 68 and the total charge for the product or service in column 69. The subtotal for all listed products and services appears at line 70, any applicable tax is listed at line 71, any shipping charges appear at line 72, any remaining, miscellaneous charges are entered at line 73, and the balance owed by the simulation participant appears at line 74.

The invoice 55 includes a remittance data block 75 containing a data field 76 which permits the simulation participant to enter his or her customer number, a data field 77 for entering the date of payment, data field 78 for entering the amount due to the creditor, and a data field 79 for listing the amount enclosed as payment. The invoice 55 is intended to expose the system participant to a variety of features that occur in real world invoicing practices, such as the use of standard invoice forms including data fields that are relevant to a particular debtor situation, irrelevant to a particular debtor situation or not readily identifiable upon cursory inspection. In this manner, the system 1 prepares the simulation participant for the variety of billing forms and practices likely to be encountered by the participant when the participant later receives actual invoices for real world goods and services.

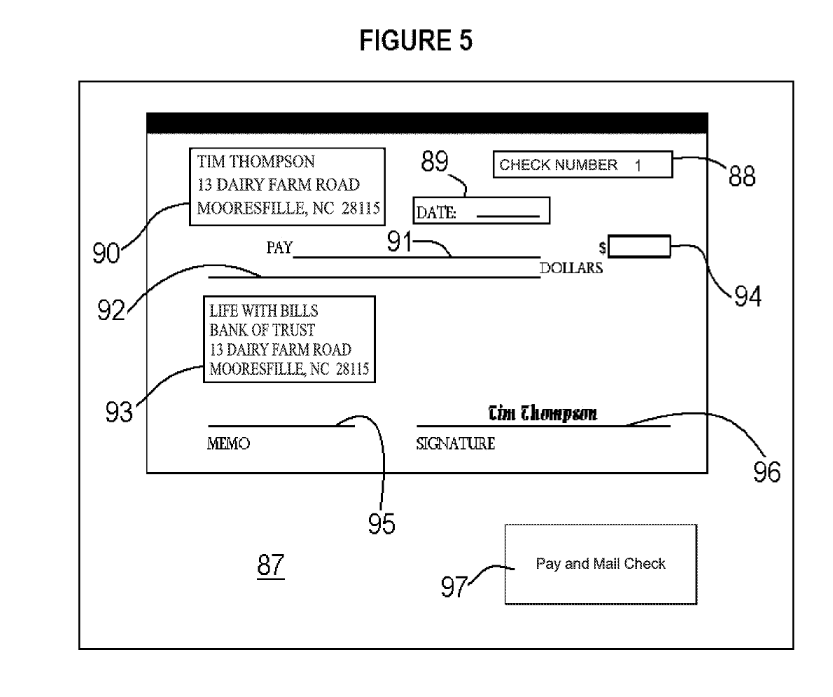

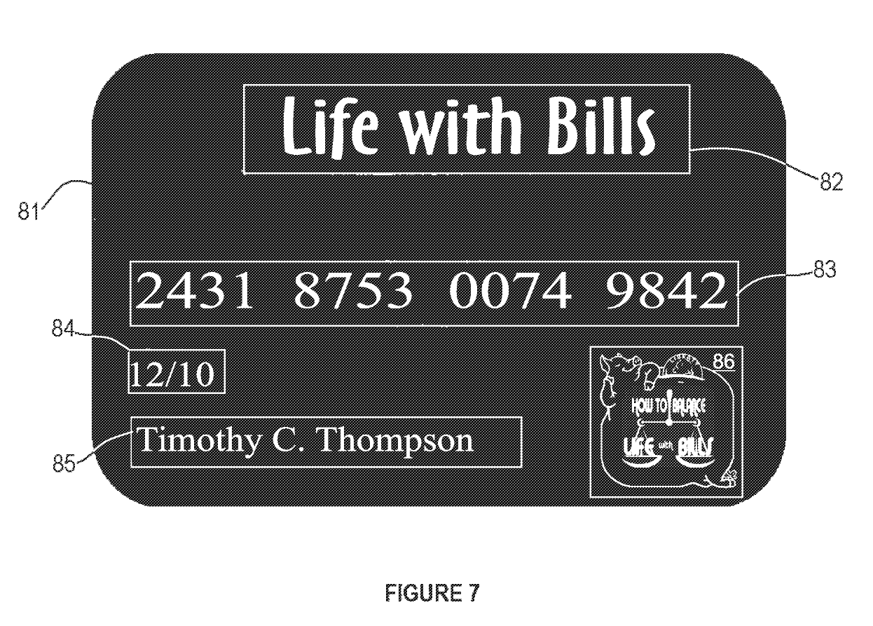

As seen in FIG. 5, the participant in the simulation is issued a number of simulated checks 87. Each simulated check 87 closely resembles an actual check and includes a number data field 88, the name of the simulation participant in data field 90 and the name of the bank in data field 93. As seen in FIG. 7, the participant is also issued a simulated credit card 81, which typically is assigned a credit limit of five hundred dollars by the simulation management staff. The simulated credit card 81 includes a data field 82 that identifies the issuing bank, a data field 86 containing the credit card logo, the credit card account number in data field 83, the expiration date of the credit card in data field 84 and the name of the simulation participant in data field 85.

Once an invoice has been received, one of the two methods of payment is selected at step 9. If the participant decides to pay an invoice with the credit card 81, an online payment can be made with the computer based simulation at step 11, or a credit card debit form may be manually filled out in the case of a paper-based simulation. In either case, the used of the credit card 81 will eventually result in the issuance of an additional credit card invoice at step 8. If the participant decides to pay all invoices by credit card, a single check will be written to pay the credit card invoice when it is received.

If the participant decides to pay any invoice using a check 81 at step 10, the participant must physically write the check at step 12 by entering the date of payment in the data field 89 and writing the amount of the payment in data field 94. The name of the creditor must be entered in data field 91, and an amount corresponding to the number entered in data field 94 must be written in words online 92. The purpose of the check must be entered on the memorandum line 95, and the simulation participant must sign the check 81 on the signature line 96. In a computer simulation of the system 1 the participant can send the check by activating the pay and mail button 97. In a paper based game embodiment of the system 1, the participant would be required to physically mail the check 81 to the creditor, either by simulated mail of the game manager is locally present, or by real mail in care of the simulation management staff if the game manager is remote. In either case, once the check 81 has been forwarded to the creditor, the participant must return to step 7 and enter the transaction in the check register 48. A check 81 that is presented without sufficient funds in the checking account will result in a thirty five dollar overdraft charge that is e-mailed or otherwise sent to the participant by the simulation manager or management staff. The overdraft charge must also be entered in the check register 48.

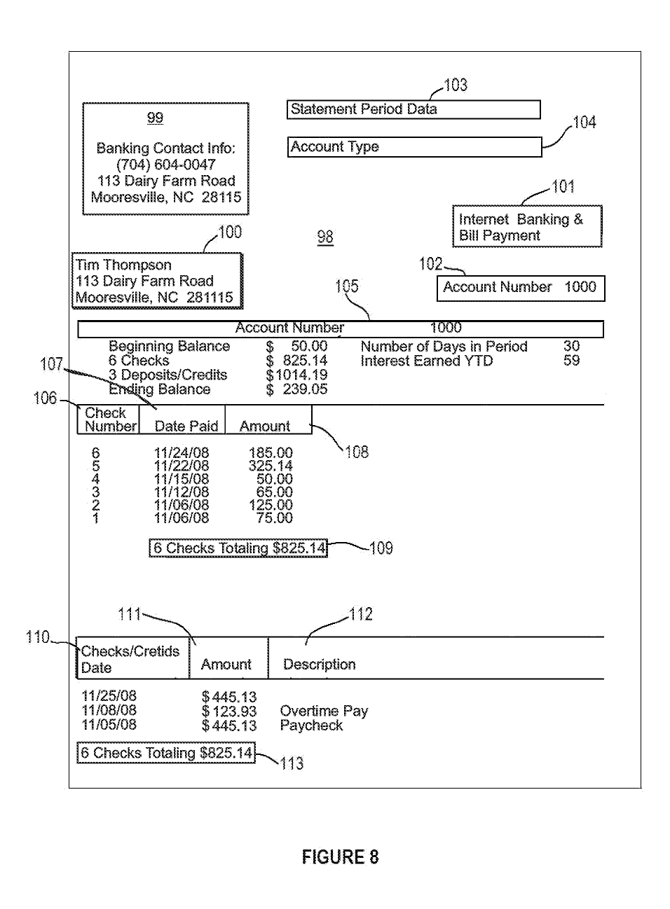

Every two weeks, the participant will be prompted by e-mail to retrieve a simulated bank statement which is then received at step 13. Referring also to FIG. 8, the front of the simulated bank statement 98 portrays the appearance of an actual bank statement including a bank identification data field 99, a statement description or identifier 101, the account holder identification data field 100, and the account number data field 102. The effective date of the statement 98 appears in data field 103 and the type of bank account is identified in data field 104. The account summary appears under heading 105, and includes a column 106 that identifies the number of each check processed by the bank, a column 107 listing the corresponding date of payment for each check listed, and a column 108 listing the amount of each listed check. The data field 109 summarizes the number of checks written and the cumulative total of all checks processed during the statement period. An additional column 110 lists the date of each deposit made by the simulation participant during the statement period. Column 111 states the amount of each deposit appearing in column 110 and column 112 describes the source of each listed deposit. The total number and cumulative amount of the deposits appears in data field 113.

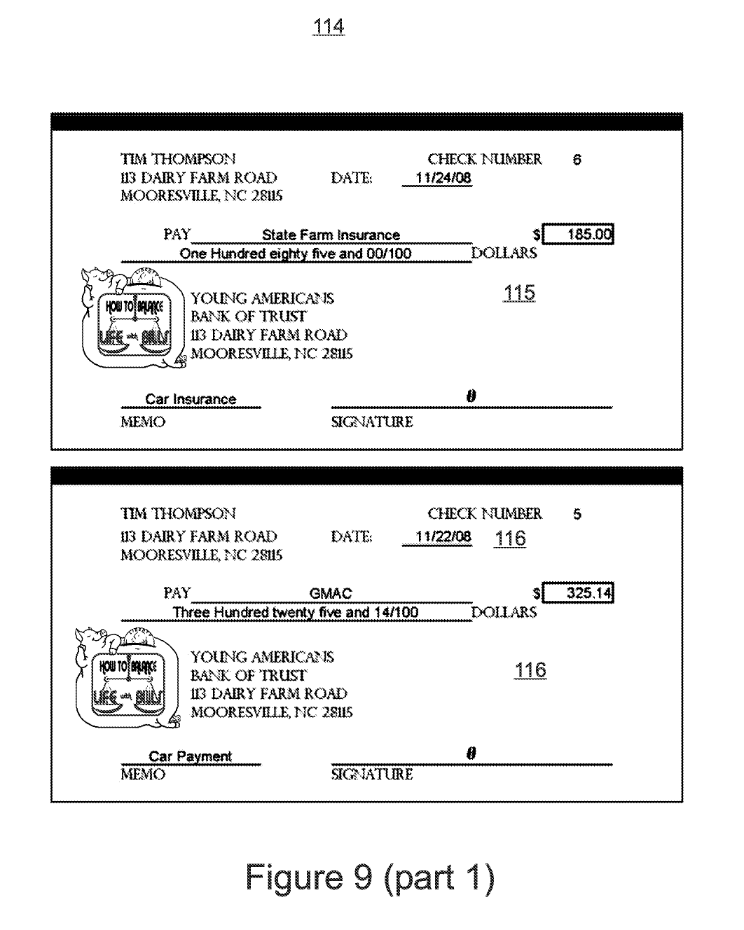

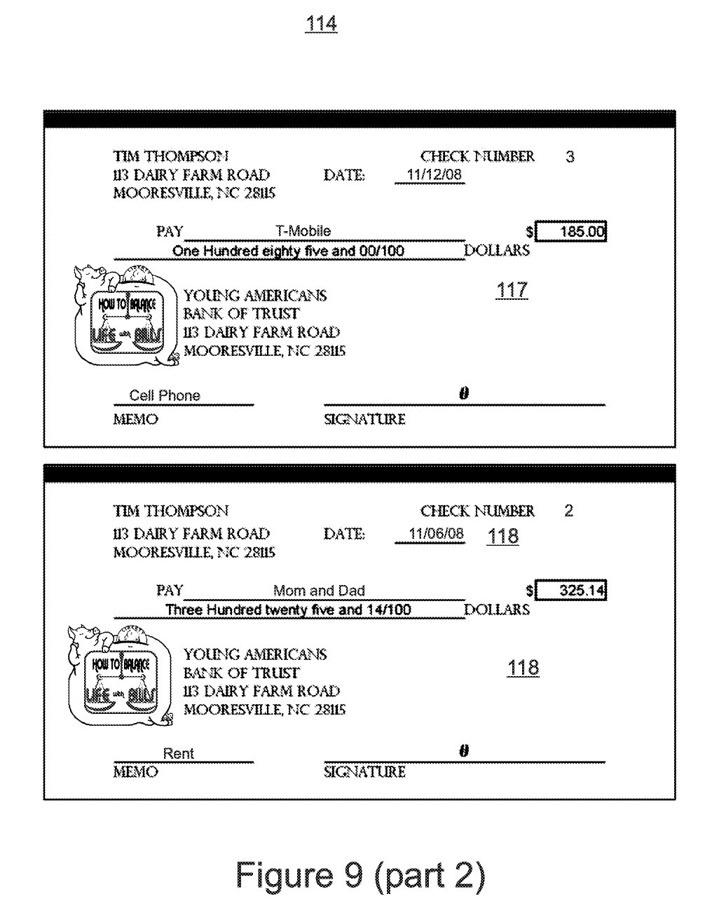

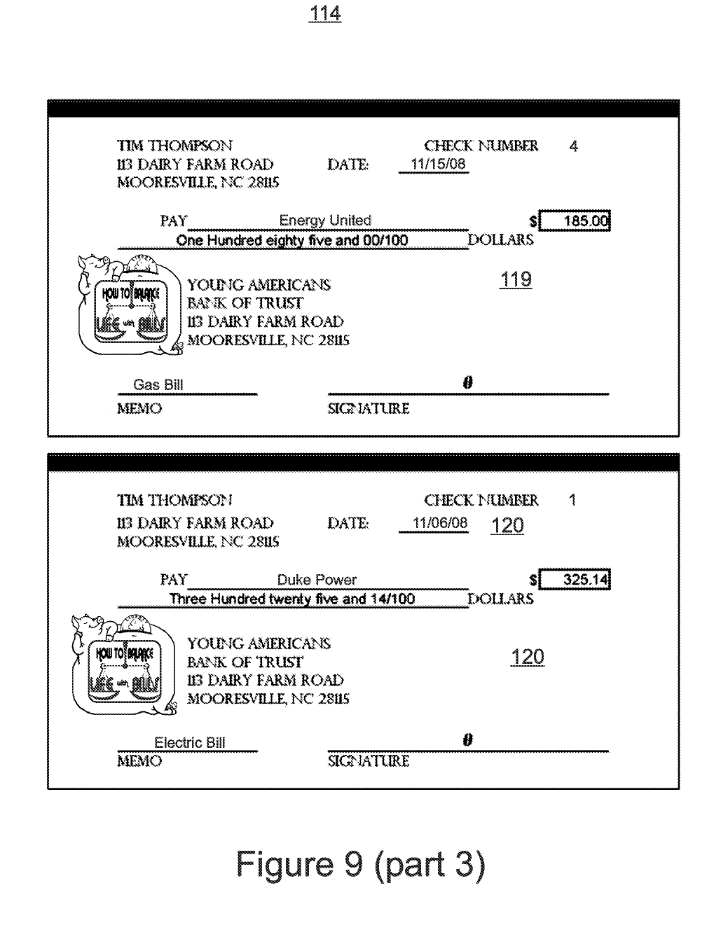

As depicted in FIG. 9, the back of the bank statement 114 includes a photocopy of each check processed by the bank during the statement period. Each check 115, 116, 117, 118, 119 and 120 corresponds to a check processed by the bank that is listed on the front of the bank statement 98. Armed with information contained in the bank statement, the simulation participant is able at step 14 to balance the check register 48. In a computer based simulation, step 14 may be performed using a spreadsheet directly on the computer, while the register may be balanced manually on a paper form in the case of a paper based game simulation. The balanced check register data is either e-mailed or mailed to the simulation management staff at step 15.

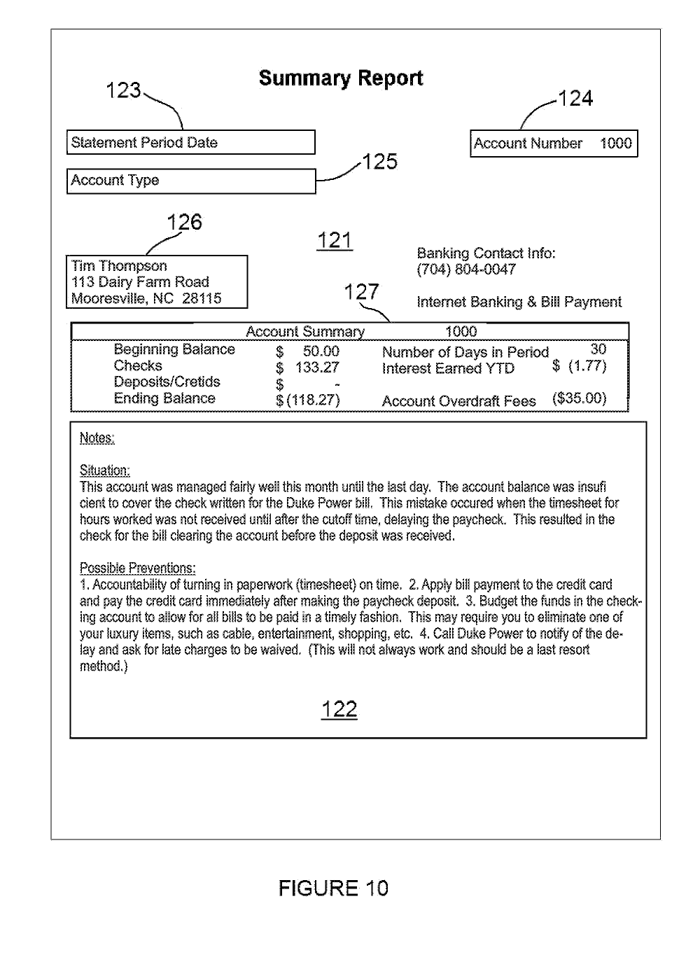

After the simulation has been active for a period of two weeks, the simulation management staff has received various items from the simulation participant as has been previously described. In response to the activities and decisions made by the simulation participant, the staff is able to evaluate the progress of the participant. Accordingly, a written evaluation is prepared by the staff and e-mailed to the participant at step 16. A typical evaluation report 121 is depicted in FIG. 10. The report identifies the simulation participant in data field 126, the type of account in data field 125, the account number in data field 124 and the period included in the report is shown in data field 123. A summary of the account activity during the relevant period is shown in data field 127.

The report 121 also includes a section 122 containing notes and remarks prepared by the simulation management team that are relevant to the choices and behavior of the simulation participant during the relevant period. The remarks section 122 will typically incorporate helpful advice which will aid the participant in avoiding common mistakes both in the context of the simulation and in the real world. In the case of an adolescent living at home, the report 121 is also typically forwarded directly to the parents of the participant to serve as a simulation report card. In the preferred embodiment of the simulation, a report 121 is generated by the simulation management staff every two weeks until the simulation ends.

The total length of the simulation is typically six weeks, although it may be increased or decreased as desired. In some cases, the simulation can proceed at a rate that is either slower or faster than real time. For example, the simulation can be run at double time, such that two simulated weeks progress during each week of real time.

In the case of a six week simulation period, the receipt of the staff evaluation report 121 requires a determination at step 17 of the time remaining in the simulation. If six weeks have elapsed when the report 121 is received, the simulation ends at step 128. If less than six weeks have passed, an additional determination of the time remaining in the simulation is made at step 18. If five weeks have elapsed, the simulation continues with the participant receiving a paycheck at step 5. If five weeks have not yet elapsed, the participant must still complete at least one more time sheet at step 3. Throughout the entire simulation, and in addition to any scheduled interaction between the participant and the simulation management staff, the participant is free to contact the staff with any questions or issues that might arise.

The foregoing features embodied in the present invention are by way of example only. Those skilled in the field of simulation based education will appreciate that the foregoing aspects may be modified as appropriate for various specific applications without departing from the scope of the claims. In particular, various other financial instruments, such as personal loans or simple contracts, as well as multiple credit cards having varying credit limits and interest rates, may be introduced to simulate more complex forms of personal financial management. Layoffs and other employment disruptions can also be introduced, as well as raises and other income-based rewards for skilled play. All of the specific time periods and monetary amounts set forth herein may be altered as necessary for particular instructional purposes.

Other modifications and implementations will occur to those skilled in the art without departing from the spirit and the scope of the invention as claimed. Accordingly, the above description is not intended to limit the invention except as indicated in the following claims.

What is claimed is:

1. A method for teaching financial management skills to a student through play of a financial simulation game, the method comprising:
providing to the student simulated financial instruments which enable the student to perform simulated financial transactions;
receiving simulated financial transactions performed by the student;
providing to the student simulated financial statements that are responsive to the simulated financial transactions performed by the student;
providing to the student simulated financial demands that require the student to perform responding financial transactions; and
repeating the above actions so as to simulate real financial activity transacted during a predetermined period of time.

2. The method of claim 1, wherein the simulated financial instruments include at least one of:
employment timesheets;
checks;
a checkbook register;
a credit card; and
bank deposit slips.

3. The method of claim 1, wherein the simulated financial statements include at least one of:
bank statements;
payment receipts; and
credit card balance statements.

4. The method of claim 1, wherein the simulated financial demands include at least one of:
bills for rent payments;
bills for food purchases;
bills for clothing purchases;
bills for car payments;
bills for payment of taxes;
bills for entertainment expenses;
bills for regular medical care;
bills for unexpected medical care; and
bills for unexpected automobile repairs.

5. The method of claim 1, wherein the financial demands include financial demands that require the student to incur and manage simulated debt.

6. The method of claim 5, wherein the financial demands are configured so as to make incurring of debt unavoidable during a first portion of the predetermined period of time, while enabling the incurred debt to be eliminated during a second portion of the predetermined period of time.

7. The method of claim 1, wherein at least some of the financial instruments are completed on paper and submitted to a game supervision staff, and the financial statements and financial demands are prepared by the game supervision staff and provided to the student on paper.

8. The method of claim 1, wherein at least some of the financial instruments are entered by the student into a computer, and the financial statements and financial demands are delivered to the student by the computer.

9. The method of claim 8, wherein the computer is one of:
a personal computer that is locally available to the student; and
a server accessed by the student over at least one of a network and the internet.

10. The method of claim 8, wherein at least some of the financial instruments are provided to a remote supervising computer, and the financial statements and financial demands are prepared by the remote supervising computer.

11. The method of claim 10, wherein the remote computer communicates with the student via the internet.

12. The method of claim 1, wherein feedback is provided to the student by a game management staff.

13. The method of claim 12, wherein the feedback includes at least one of advice regarding how to play the game and indications of a degree of success demonstrated by the student while playing the game.

14. The method of claim 1, wherein the predetermined period of time is six weeks.

15. The method of claim 1, wherein the predetermined period of time represents a compression of real time.

16. The method of claim 1, wherein a summary report is provided to the student at the end of the predetermined period of time.

17. The method of claim 16, wherein the summary report includes at least one of:
timeliness of submission of employment time sheets;
timeliness of bill payments;
frequency of rejection of submitted checks due to insufficient bank account funds;
total amount of credit card interest paid; and
total amount of luxuries purchased.

18. The method of claim 1, wherein a game score is awarded to the student at the end of the predetermined period of time.

19. An article of manufacture for teaching financial management skills to a student through play of a financial simulation game, the article of manufacture comprising:
media containing software operable on a computer so as to cause the computer to:
provide to the student simulated financial instruments which enable the student to perform simulated financial transactions;
receive simulated financial transactions performed by the student;
provide to the student simulated financial statements that are responsive to the simulated financial transactions performed by the student;
provide to the student simulated financial demands that require the student to perform responding financial transactions; and
repeat the above actions so as to simulate real financial activity transacted during a predetermined period of time.

20. The article of manufacture of claim 19, wherein the computer is a remote computer that is able to receive simulated financial instruments from the student and to provide simulated financial statements and simulated financial demands to the student via communication over at least one of a network and the internet.
